(19) United States
(12) Patent Application Publication
(10) Pub. No.: US 2026/0241822 A1
(43) Pub. Date: Aug. 20, 2026

(54) INTELLECTUAL SCHEDULING METHOD OF SHARED STORAGE AND CHARGING SYSTEM FOR INDUSTRIAL AND COMMERCIAL PARK BASED ON REINFORCEMENT LEARNING

(71) Applicant: Fudan University, Shanghai (CN)

(72) Inventors: Yu Wang, Shanghai (CN); Yaojie Sun, Shanghai (CN); Yuqing Zhao, Shanghai (CN); Baligen Talihati, Shanghai (CN); Shiyi Fu, Shanghai (CN); Bowen Zhang, Shanghai (CN)

(21) Appl. No.: 19/361,694

(22) Filed: Oct. 17, 2025

(30) Foreign Application Priority Data
Feb. 17, 2025 (CN) 202510168738.7

(51) Int. Cl. B60L 53/51; B60L 53/10; B60L 53/64; G06F 30/27; G06F 111/04; G06F 113/04; G06F 119/04; G06F 119/06; G06Q 50/06

(52) U.S. Cl. CPC B60L 53/51; B60L 53/11; B60L 53/64; G06F 30/27; G06Q 50/06; G06F 2101/02; G06F 2101/08; G06F 2101/14; G06F 2111/04; G06F 2113/04; G06F 2119/04; G06F 2119/06

(57) ABSTRACT

An intellectual scheduling method of a shared storage and charging system for an industrial and commercial park based on reinforcement learning is provided. This method models various types of loads in the industrial and commercial park, establishes a model for an energy storage and photovoltaic system, analyzes its charging and discharging characteristics, and calculates a degradation cost of a battery. By designing a reasonable reward function, a reinforcement learning algorithm is guided to make optimal charging and discharging decisions at different times to maximize overall benefits of the industrial and commercial park. A reinforcement learning agent constantly selects an action based on a current state, implements a corresponding charging and discharging strategy, and optimizes the strategy through a feedback reward signal. Through multiple iterations, an optimal scheduling method is gradually found to ensure a balance between power supply and demand, reduce energy waste, and extend battery service life.

### CROSS REFERENCE TO RELATED APPLICATION

This patent application claims the benefit and priority of Chinese Patent Application No. 202510168738.7, filed with the China National Intellectual Property Administration on Feb. 17, 2025, the disclosure of which is incorporated by reference herein in its entirety as part of the present application.

### TECHNICAL FIELD

The present disclosure belongs to the field of intellectual grids and energy management, and specifically relates to an intellectual scheduling method of a shared storage and charging system for an industrial and commercial park based on reinforcement learning. The method is intended to optimize a charging and discharging strategy of an energy storage system to reduce electricity costs, improve energy utilization efficiency, effectively alleviate large-scale grid load pressure, support safe operation of large grids, and extend a service life of an energy storage battery.

### BACKGROUND

With a transformation of a global energy structure and a wide application of new energy sources, energy management in an industrial and commercial park has gradually become a research hotspot. In particular, with popularization of electric vehicles and introduction of renewable energy sources such as photovoltaics, complexities of energy demands and supplies within the industrial and commercial park continue to increase. An existing traditional grid system is difficult to meet such diversified demands, resulting in high dependence of the industrial and commercial park on a grid. In addition, due to a degradation problem of a battery energy storage system, it is difficult to achieve long-term stable operation. Therefore, how to optimize a charging and discharging strategy of the energy storage system while ensuring loads in the industrial and commercial park has become a key issue to improve economic efficiency and sustainability of an energy system. Currently, although some studies have attempted to reduce electricity costs and battery losses by optimizing scheduling of the battery energy storage system, due to diversity and uncertainty of the energy management, traditional scheduling methods often fail to achieve ideal results in practical scenarios. Moreover, due to large load fluctuations within the industrial and commercial park, how to reasonably schedule an energy storage device to meet electricity demand while extending a service life of the energy storage system has become a key issue to be solved in this field. The traditional scheduling methods often fail to balance battery life, electricity costs, and overall system performance. Therefore, an intellectual scheduling method based on reinforcement learning is required to achieve efficient optimization of electric energy scheduling and resource sharing.

### SUMMARY

It is an object of the present disclosure to provide an intellectual scheduling method of a shared storage and charging system for an industrial and commercial park based on reinforcement learning. The present disclosure optimizes charging and discharging scheduling of the energy storage and photovoltaic (ES-PV) system for the industrial and commercial park to reduce power costs, and decrease degradation losses of the energy storage system, thereby improving overall economic efficiency and resource utilization efficiency of the system.

In the present disclosure, load models of various electrical devices within the industrial and commercial park are established, considering energy consumption characteristics and load demands of different devices. Meanwhile, for the shared energy storage system for the industrial and commercial park, a mathematical model for its charging and discharging characteristics, capacity, and a degradation cost is established. By using a reinforcement learning algorithm to schedule the charging and discharging decisions of the ES-PV system, the system can satisfy load demands while reducing battery degradation and wear and electricity costs.

The intellectual scheduling method of a shared storage and charging system for an industrial and commercial park based on reinforcement learning proposed in the present disclosure specifically includes the following steps:
(1) by modeling various types of loads in the industrial and commercial park that contains a shared ES-PV system, controlling an energy balance of a shared ES-PV system to achieve intellectual scheduling and optimized management of energy, with a key focus on an electricity demand of a park user, a charging demand of an electric vehicle, and a supply situation of photovoltaic power generation;
(2) establishing a model of the shared ES-PV system, analyzing its charging and discharging characteristics, and calculating a degradation cost of a battery; and
(3) by designing a reasonable reward function, a reinforcement learning algorithm is guided to make optimal charging and discharging decisions at different times to maximize overall benefits of the industrial and commercial park; in this process, a reinforcement learning agent constantly selects an action based on a current state, implements a corresponding charging and discharging strategy, and optimizes the strategy through a feedback reward signal; and the system, through multiple iterations, gradually finds an optimal scheduling method to ensure a balance between power supply and demand, reduce energy waste, and extend battery service life.

In the present disclosure, the modeling in step (1) is to establish interaction relationships among an energy storage device, an electric vehicle, and another load. Specifically, the energy storage device in the modeling can be used as an emergency power source and can also perform charging during peak electricity price periods to reduce dependence on a distribution network, and various types of loads in the industrial and commercial park include:
the energy storage device is used to store electric energy that cannot be consumed immediately in the industrial and commercial park, and a mathematical model for the energy storage device is shown in Formula (1):

$${S}_{e {v}_{d , t + 1}} = {S}_{e {v}_{d , t}} + {P}_{d , t} ΔT ∀ t ∈ T \qquad ( 1 )$$

where: Sₑᵥ_{_{d,t}} is a state of the energy storage device at time t, P_{d,t} is a charging and discharging power, and ΔT is a time step;
a capacity range of the energy storage device is constrained by:

$${p}_{d o d} {S}_{e {v}_{max}} \leq {S}_{e {v}_{d , t}} \leq {S}_{e {v}_{max}} ∀ t ∈ T \qquad ( 2 )$$

$${e}_{d , t} {P}_{e {v}_{min}} \leq {P}_{d , t} \leq {e}_{d , t} {P}_{e {v}_{max}} ∀ t ∈ T \qquad ( 3 )$$

$${e}_{d , t} ∈ \{ 0 , 1 \} ∀ t ∈ T \qquad ( 4 )$$

$${S}_{e {v}_{d , 19}} \leq {p}_{st} {S}_{e {v}_{max}} ∀ t ∈ T \qquad ( 5 )$$

$${S}_{e {v}_{d , 7}} \geq {p}_{e d} {S}_{e {v}_{max}} ∀ t ∈ T \qquad ( 6 )$$

where: P_{dod} is a lower limit of a discharging power of the device, Sₑᵥ_{ₘₐₓ} is a maximum storage capacity of the device, eat is a charging and discharging state of the storage device at time t, Pₑᵥ_{ₘₐₓ} is an upper limit of a charging power, Sₑᵥ_{_{d,19}} and Sₑᵥ_{_{d,7}} are states of the device at times t=19 and t=7, respectively, Pₛₜ is an upper limit coefficient of the charging power, and Ped is a state of electric vehicle charging; Formula (2)-Formula (6) are charging and discharging states and capacity limits of the energy storage device in different time periods;
the electric vehicle is an indispensable load in the industrial and commercial park, and charging scheduling of the electric vehicle varies according to different charging modes, where the electric vehicle adopts a home charging mode, that is, a vehicle owner starts charging after returning home from work and stops charging when leaving for work; a start time of the electric vehicle charging follows a normal distribution, and its probability density function is:

$${f}_{t} ( x ) = \{ \begin{matrix}\frac{1}{{σ}_{s} \sqrt{2 π}} exp ( - \frac{{( x - {μ}_{s} )}^{2}}{2 {σ}_{s}^{2}} ) {μ}_{s} - 12 < x < 24 \\ \frac{1}{{σ}_{s} \sqrt{2 π}} exp ( - \frac{{( x + 24 - {μ}_{s} )}^{2}}{2 {σ}_{s}^{2}} ) 0 < x < {μ}_{s} - 12\end{matrix} \qquad ( 7 )$$

where: parameters σₛ and μₛ respectively represent a standard deviation and mean of the normal distribution controlling the start time of the electric vehicle charging, σₛ=3.3, μₛ=18; according to Formula (7), a charging start time table for the electric vehicle is obtained, and then charging is performed for the vehicle owner according to a corresponding charging mode;
a capacity of the electric vehicle in the industrial and commercial park follows a uniform distribution, as shown in Formula (8); where 20-60 kWh represents a common capacity range of electric vehicles on a market; a probability that the electric vehicle in the industrial and commercial park has a capacity within this range is uniformly distributed:

$${f}_{c} ( x ) = \{ \begin{matrix}\frac{1}{40} & 20 < x < 60 \\ 0 & otherwise\end{matrix} \qquad ( 8 )$$

a charging formula for the electric vehicle is similar to that of the energy storage device and follows a charging process of a lithium-ion battery; the charging process is expressed as Formula (9) and Formula (10):

$${SOC}_{i , t + 1} = {SOC}_{i , t} + \frac{{P}_{i , t}^{e v}}{{Q}_{i , t}^{e v}} Δ t \qquad ( 9 )$$

$${SOC}_{min} \leq {SOC}_{i , t} \leq {SOC}_{max} \qquad ( 10 )$$

where:

$${P}_{i , t}^{ev}$$

is a charging power of the electric vehicle, and

$${Q}_{i , t}^{ev}$$

is a battery capacity of the electric vehicle, determined by a uniform distribution equation for determining a capacity of electric vehicles in the industrial and commercial park; SOCₘᵢₙ ensures that the electric vehicle is charged to a minimum required state of charge (SOC) for operation to mainly prevent deep discharge of an electric vehicle battery during discharge, thereby extending a service life of the electric vehicle battery; and SOCₘₐₓ corresponds to a maximum SOC that the electric vehicle can reach to prevent overcharging of the electric vehicle;
charging modes of the electric vehicle include a quick charging mode and an intellectual charging mode; the quick charging mode is suitable for emergency charging demand and can achieve a full charge in a relatively short time, but the charging power is high, which may have an impact on battery life; the intellectual charging mode is suitable for a user who is not in a hurry to charge, in which a charging power is relatively low and can be dynamically adjusted according to an overall load in the industrial and commercial park and electricity price fluctuations, so as to reduce charging costs and avoid excessive load on a grid; and
limits of the charging power are as follows:

$${P}_{i , t}^{ev} = \{ \begin{matrix}{P}^{ev , max} & quick charging \\ 0 \leq {P}_{i , t}^{ev} \leq {P}^{ev , max} & intellectual charging\end{matrix} \qquad ( 11 )$$

where:

$${P}_{i , t}^{ev}$$

is the charging power of the electric vehicle, where in the quick charging mode, the charging power equals a maximum allowable power of a charging pile in the industrial and commercial park, which is 20 kWh, and in the intellectual charging mode, the charging power ranges from 0 to the maximum power and varies according to an overall load curve of the industrial and commercial park and real-time electricity price fluctuations, thereby achieving two objects: one is to prevent excessive electric vehicle charging in the industrial and commercial park during peak periods that could put pressure on the distribution network of the industrial and commercial park, and the other is to complete a charging demand while avoiding peak electricity price periods, thereby reducing charging costs for the vehicle owner.

In the present disclosure, the industrial and commercial park described in step (2) is equipped with the shared ES-PV system, and particularly during load peak periods, the shared ES-PV system is required to give priority to satisfying internal loads of the industrial and commercial park; to effectively reduce dependence of loads in the industrial and commercial park on the power distribution network, because during an off-peak period, a load pressure on the distribution network is relatively low; and therefore, the various types of loads in the industrial and commercial park is required to satisfy an electric energy balance constraint;
an electric energy balance constraint formula is as follows:

$${L}_{t} = {L}_{t}^{basic} + {P}_{t}^{fleet} \qquad ( 12 )$$

where: Lₜ is a total power demand of the industrial and commercial park, which consists of two parts, a first part being

$${L}_{t}^{basic} ,$$

that is, a basic load of the park, including a power demand for daily electricity consumption, such as electricity for lighting, air conditioning, and other basic facilities; a second part being

$${P}_{t}^{fleet} ,$$

that is, an electric vehicle charging load in the industrial and commercial park, a size of which is determined by a penetration rate of electric vehicles in the industrial and commercial park, that is, if a charging power of one electric vehicle is

$${P}_{i , t}^{ev} ,$$

then a total fleet power of the industrial and commercial park basically depends on how many electric vehicles are equipped in the park; and the electric vehicle charging load is not included in the basic load and is required to be independently optimized and scheduled.

In the present disclosure, the reward function in the reinforcement learning described in step (3) plays a core role in guiding an agent's decision-making, determines how the agent evaluates its behavior, and directs the agent to approximate an objective behavior; by reinforcement learning, the charging and discharging decisions of an energy storage system for the industrial and commercial park are optimized, especially during load peak periods, where the energy storage system should undertake part of the load pressure;
in order to constrain the agent when behaviors that do not conform to the objective occur, a penalty function is adopted to reduce such behaviors; the penalty function is defined as:

$${Penalty}_{t}^{waste} = {P}_{t}^{waste} \qquad ( 13 )$$

where:

$${P}_{t}^{waste}$$

represents energy waste generated at this time step, specifically, a surplus electric energy from photovoltaic power generation that is not fully utilized, or an energy discharged by the energy storage system that exceeds a demand of the industrial and commercial park;
an energy output of a photovoltaic power generation system is required to satisfy a power demand of the industrial and commercial park and minimize waste; an energy balance formula (14) for the photovoltaic system is as follows:

$${G}_{t} = {P}_{t}^{p , c} + {P}_{t}^{p , e} + {P}_{t}^{pv , waste} \qquad ( 14 )$$

where: Gₜ represents electric energy generated by the photovoltaic system at each time, a part of the electric energy is used by a user in the industrial and commercial park, denoted as

$${P}_{t}^{p , c} ;$$

a part is stored by the energy storage, denoted as

$${P}_{t}^{p , e} ;$$

if there is still remaining photovoltaic electric energy, it is denoted as

$${P}_{t}^{pv , waste} ,$$

indicating that this part of the electric energy is wasted;
a power demand of the user in the industrial and commercial park is also required to satisfy an electric energy balance constraint, so as to ensure a reasonable distribution of loads in the industrial and commercial park among various energy inputs; an energy balance formula for the user is as follows:

$${L}_{t} = {P}_{t}^{p , c} + {P}_{t}^{dis} + {P}_{t}^{g , c} - {P}_{t}^{e , waste} \qquad ( 15 )$$

where: Lₜ is a total power demand of the industrial and commercial park, a part of which comes from photovoltaic power generation, that is,

$${P}_{t}^{p , c} ;$$

a part comes from discharging of the energy storage system, that is,

$${P}_{t}^{d i s} ;$$

and another part depends on the grid, that is

$${P}_{t}^{g , c} ;$$

if discharging of the energy storage system far exceeds a load demand of the industrial and commercial park, it is denoted as

$${P}_{t}^{e , waste} ,$$

indicating that this part of energy is wasted;
charging electric energy of the energy storage system comes from purchased electricity from the grid and comes from power generation of the photovoltaic system; a charging power formula for the energy storage system is as follows:

$${P}_{t}^{c h} = {P}_{t}^{g , e} + {P}_{t}^{p , e} \qquad ( 16 )$$

where:

$${P}_{t}^{g , e}$$

is charging power from the grid, and

$${P}_{t}^{p , e}$$

is charging power from the photovoltaic power generation system;

$${P}_{t}^{waste} = {P}_{t}^{pv , waste} + {P}_{t}^{e , waste} \qquad ( 17 )$$

the energy waste

$${P}_{t}^{waste}$$

generated in the entire industrial and commercial park comes from photovoltaic power generation that fails to be fully utilized, resulting in photovoltaic electric energy waste,

$${P}_{t}^{pv , waste} ,$$

and comes from discharging of the energy storage far exceeding a demand of the industrial and commercial park, resulting in electric energy waste of energy storage

$${P}_{t}^{e , waste} ;$$

and this part of electric energy waste not only affects power supply efficiency of the industrial and commercial park but also increases an energy consumption burden of the system, and therefore, in reinforcement learning, a penalty is required to reduce unnecessary waste behaviors,
the reward function ensures that the shared ES-PV system can undertake loads in the industrial and commercial park through an electric energy balance of the industrial and commercial park;
electric energy costs of the industrial and commercial park are required to consider electric energy purchase costs from the grid and from the energy storage system, which are calculated as Formula (18):

$${Cost}_{t}^{s} = {\prod }_{t}^{*} ( {P}_{t}^{g , c} + {P}_{t}^{g , e} ) \qquad ( 18 )$$

where:

$${Cost}_{t}^{s}$$

is the electric energy costs of the entire industrial and commercial park,

$${\prod }_{t}^{*}$$

is an actual electricity price based on a local electricity price standard,

$${P}_{t}^{g , c}$$

is electric energy purchased from the grid by the industrial and commercial park, and

$${P}_{t}^{g , e}$$

is electric energy purchased from the grid by the energy storage system; the electric energy costs are closely related to fluctuations in loads in the industrial and commercial park and electricity prices of the grid; and therefore, adopting an optimized electric energy purchasing approach can significantly reduce electricity costs of the industrial and commercial park;
a charging behavior of the energy storage system not only involves electric energy storage but also causes cost losses, especially battery wear; the cost losses caused by the charging behavior of the energy storage system are calculated as Formula (19):

$${Cost}_{t}^{w e a r} = \frac{{c}_{E}}{η D {L}_{C}} \vert {P}_{t}^{bat} \vert \qquad ( 19 )$$

where: C_{E} is a unit energy cost of the battery, which can be an initial cost or a replacement cost of the battery; D is a depth of discharge of the battery, which represents a degree of discharge; L_{c} is a cycle life of the battery, which represents the number of charging and discharging cycles that the battery can undergo under specific depth of discharge and conditions; a wear cost of the battery is related to an energy cost, efficiency, depth of discharge, cycle life, and charging and discharging power; by reasonably managing the charging and discharging strategy, the battery life can be effectively extended, and the wear cost can be reduced;
a reward function of the industrial and commercial park is as shown in Formula (20):

$$R e a w a r {d}_{t}^{s} = - {Cost}_{t}^{s} - {Cost}_{t}^{wear} - {Penalty}_{t}^{waste} \qquad ( 20 )$$

where:

$$R e a w a r {d}_{t}^{s}$$

is a reward of the industrial and commercial park at time t;

$$Cos {t}_{t}^{s}$$

is the electric energy costs of the industrial and commercial park, and an objective is to reduce power costs so as to reduce dependence of the industrial and commercial park on the grid;

$${Cost}_{t}^{w e a r}$$

is a wear cost or the energy storage system, which both considers a long-term health of the energy storage system and optimizes a usage degree of the battery;

$${Penalty}_{t}^{waste}$$

is a penalty function to reduce electric energy waste and ensure efficient operation of the system; and
through the reward function, the shared ES-PV system can self-adjust the charging and discharging strategy in a reinforcement learning process, not only optimizing economic costs but also extending a service life of the energy storage system and reducing energy waste, thereby achieving effective management of loads in the industrial and commercial park and reducing dependence on the distribution network.

In the present disclosure, the reinforcement learning algorithm described in step (3) is used to control the charging and discharging decisions of the energy storage system for the industrial and commercial park, where the system forms an optimal usage strategy based on different time situations, thereby maximizing a long-term reward of the industrial and commercial park;
a core task of the reinforcement learning is to enable the agent (which in this scenario is a scheduling controller of the energy storage system for the industrial and commercial park) to learn in an environment to maximize its long-term return through a series of actions; in this application scenario, the “actions” of the agent refer to decisions on a degree of charge and discharge of the energy storage system, and an objective is to maximize the reward function of the industrial and commercial park through these decisions, so as to ensure that while satisfying a load demand of the industrial and commercial park, power costs are reduced, a service life of the energy storage system is extended, and energy waste is reduced;
in a reinforcement learning framework, a state of the environment at each step is a random variable; in this case, the state of the environment is determined by multiple factors such as a current charging state of the energy storage system, the load demand, and a photovoltaic power generation amount; assuming that at a certain time, the agent is in a state St, takes an action at, and then transits to a next state sₜ₊₁ and obtains a reward

$$R e a w a r {d}_{c}^{s} ,$$

then a state transition process can be expressed as:

$${s}_{t + 1} = f ( {s}_{t} , {a}_{t} ) \qquad ( 21 )$$

where: f is a state transition function, which represents a change of an environmental state after a certain action is taken in a certain state;
an objective of the agent is to maximize its cumulative return by selecting an appropriate action sequence; this is usually achieved through a value function; given a current time t, the cumulative return Gₜ is a weighted sum of all rewards from performing actions starting from the current time to a termination time:

$${G}_{t} = {r}_{t + 1} + γ {r}_{t + 2} + {γ}^{2} {r}_{t + 3} + … = {Σ}_{k = 0}^{∞} {γ}^{k} {r}_{t + k + 1} \qquad ( 22 )$$

where: γ is a discount factor, generally between 0≤γ≤1; the discount factor controls a weight of future rewards, and the smaller the value is, the smaller an influence of future rewards on a current decision is; and the reward function rₜ₊₁ in the formula is actually a simplified representation of

$$R e a w a r {d}_{t + 1}^{s} ,$$

that is, the reward function evaluates an influence of the current decision on the agent;
a policy π defines a probability distribution of an action taken by the agent in each state, and the policy can be deterministic or stochastic;

$$π ( a \vert s ) = P ( {a}_{t} = a \vert {s}_{t} = s ) \qquad ( 23 )$$

the stochastic policy is shown in Formula (23), which represents a probability of taking an action a in a state s; in practical applications, the stochastic policy can help explore different decision paths to find an optimal policy;
a reinforcement learning method adopts a Q-learning method based on value iteration and gradually approximates the optimal policy by constantly updating an action value function; in the Q-learning method, each pair of state St and action at has a corresponding Q value representing an expected return of taking the action in the state; an update rule of the Q-learning method is as follows:

$$Q ( {s}_{t} , {a}_{t} ) ← Q ( {s}_{t} , {a}_{t} ) + α ( {r}_{t + 1} + {γmax}_{{a}^{′}} Q ( {s}_{t + 1} , {a}^{′} ) - Q ( {s}_{t} , {a}_{t} ) ) \qquad ( 24 )$$

where: α is a learning rate that controls a step size of each update; maxₐ,Q(sₜ₊₁, a′) is a Q value corresponding to an optimal action among all possible actions a′ taken in a new state sₜ₊₁, and
by constantly iterating and updating the Q value, the Q-learning method can gradually find the optimal policy, that is, to take an optimal action in each state to maximize the cumulative return.

The present disclosure has the following beneficial effects: the present disclosure maximizes utilization of renewable energy and reduces dependence on a traditional grid by optimizing the charging and discharging strategy of the energy storage system. Through an optimization of the reinforcement learning algorithm, costs of purchasing electricity from the grid is minimized, and the energy storage system is reasonably scheduled to reduce overall electricity costs. While optimizing the electricity costs, battery degradation is considered to ensure a healthy use of an energy storage battery. Through a penalty mechanism, waste of photovoltaic electric energy and electric energy from the energy storage system is reduced, further improving overall economic efficiency of the system. This framework can be extended and applied to industrial and commercial parks of different scales and types, has strong adaptability, and is particularly suitable for implementation in intellectual grids and multi-microgrid environments.

The present disclosure provides an innovative intellectual scheduling method of a shared storage and charging system for an industrial and commercial park based on reinforcement learning, which can effectively solve various challenges in electric energy scheduling under a multi-microgrid sharing architecture, optimize an operation of the energy system of the industrial and commercial park, improve energy use efficiency and economic efficiency, and enhance safety and stability of the grid, having broad application prospects and promotion value.

### BRIEF DESCRIPTION OF THE DRAWINGS

To more clearly illustrate the technical solutions in the embodiments of the present disclosure or in the conventional technology, the accompanying drawings required for the embodiments or the conventional technology will be briefly described below.

FIG. 1 shows a flow chart of an intellectual scheduling method of a shared storage and charging system for an industrial and commercial park based on reinforcement learning according to the present disclosure; and

FIG. 2 shows a framework diagram of an energy balance in an industrial and commercial park in an intellectual scheduling method of a shared storage and charging system for an industrial and commercial park based on reinforcement learning according to the present disclosure.

### DETAILED DESCRIPTION OF THE EMBODIMENTS

To make the objects, technical solutions, and advantages of embodiments of the present disclosure clearer, the technical solutions in the embodiments of the present disclosure are described clearly and completely below with reference to the accompanying drawings in the embodiments of the present disclosure. Apparently, the embodiments described are some rather than all of the embodiments of the present disclosure.

Embodiment 1: In an intellectual scheduling method of a shared storage and charging system for an industrial and commercial park based on reinforcement learning, the industrial and commercial park is equipped with different types of load equipment, including a base electricity load and electric vehicles. The industrial and commercial park is also equipped with a shared ES-PV system, which includes photovoltaic panels and centralized energy storage. The collaborative work among these devices can provide a sufficient energy supply. Through the shared ES-PV system, load demands and energy supplies in different areas are optimally scheduled.

A main object of the present disclosure is to achieve the optimized scheduling of the shared energy storage system for the industrial and commercial park, so as to minimize an electricity cost and a degradation cost of the energy storage system, and improve comprehensive energy utilization efficiency. Through a reinforcement learning algorithm, based on actual load demands and renewable energy supplies, charging and discharging decisions of the ES-PV system are adjusted, thereby optimizing overall performance and economic efficiency of the system.

In the present disclosure, the reinforcement learning algorithm is used to dynamically adjust a charging and discharging strategy of the energy storage system. First, a reward function is designed to consider electricity demands of various types of devices in the industrial and commercial park, energy costs, and degradation losses of the energy storage system. By setting an objective function, the algorithm aims to minimize a weighted sum of the electricity cost and the degradation cost of the battery. To achieve this objective, the system dynamically adjusts a charging and discharging amount of the energy storage system through real-time monitoring of loads, energy production, and a state of the energy storage system.

This method utilizes the Q-learning strategy in the reinforcement learning algorithm to constantly optimize the strategy and improve accuracy and efficiency of the charging and discharging decisions. Specifically, at each time step, a state of the energy storage system for the industrial and commercial park (such as remaining battery capacities, load demands, energy supplies) is used as an input. The reinforcement learning agent selects an optimal charging and discharging operation based on the current state and evaluates an effect of the current decision through the reward function. As the training progresses, the agent gradually learns optimal charging and discharging strategies under various different situations.

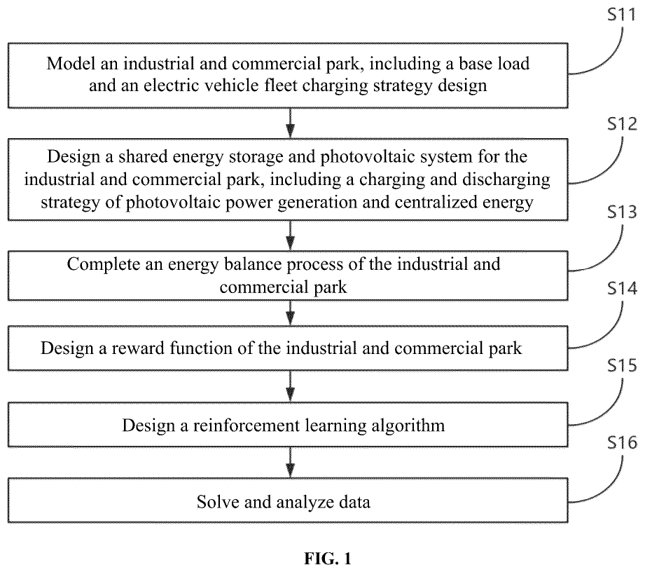

FIG. 1 shows a flow chart of an intellectual scheduling method of a shared storage and charging system for an industrial and commercial park based on reinforcement learning according to the present disclosure; and

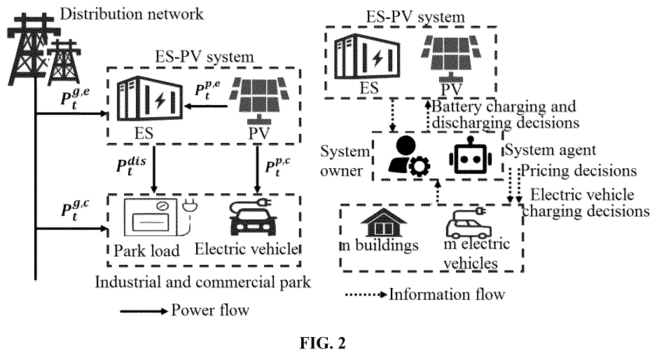

FIG. 2 shows a framework diagram of an energy balance in an industrial and commercial park in an intellectual scheduling method of a shared storage and charging system for an industrial and commercial park based on reinforcement learning according to the present disclosure. It can be seen that the industrial and commercial park is equipped with a user base electricity load, a vehicle fleet charging demand, and a shared ES-PV system for the industrial and commercial park. The method includes:
modeling various types of loads in the industrial and commercial park that contains a shared ES-PV system, especially establishing interaction relationships among an energy storage device, an electric vehicle, and other loads. Specifically, the energy storage device in this system can be used as an emergency power source and can also perform charging during peak electricity price periods to reduce dependence on a distribution network. The various types of loads in the industrial and commercial park include: the energy storage device is used to store electric energy that cannot be consumed immediately in the industrial and commercial park, and a mathematical model for energy storage is shown below:

$$\begin{matrix}{S}_{e {v}_{d , t + 1}} = {S}_{e {v}_{d , t}} + {P}_{d , t} Δ T & ∀ t ∈ T\end{matrix}$$

where: Sₑᵥ_{_{d,t}} is a state of the energy storage device at time t, P_{d,t} is a charging and discharging power, and ΔT is a time step.

A capacity range of the energy storage device is constrained by:

$${p}_{dod} {S}_{e {v}_{max}} \leq {S}_{e {v}_{d , t}} \leq {S}_{e {v}_{max}} \qquad ∀ t ∈ T$$

$${e}_{d , t} {P}_{e {v}_{min}} \leq {P}_{d , t} \leq {e}_{d , t} {P}_{e {v}_{max}} \qquad ∀ t ∈ T$$

$${e}_{d , t} ∈ \{ 0 , 1 \} \qquad ∀ t ∈ T$$

$${S}_{e {v}_{d , 19}} \leq {p}_{st} {S}_{e {v}_{max}} \qquad ∀ t ∈ T$$

$${S}_{e {v}_{d , 7}} \geq {p}_{e d} {S}_{e {v}_{max}} \qquad ∀ t ∈ T$$

where: P_{dod} is a lower limit of a discharging power of the device, Sₑᵥ_{ₘₐₓ} is a maximum storage capacity of the device, eat is a charging and discharging state of the storage device at time t, Pₑᵥ_{ₘₐₓ} is an upper limit of a charging power, Sₑᵥ_{_{d,19}} and Sₑᵥ_{_{d,7}} are states of the device at times t=19 and t=7, respectively, Pₛₜ is an upper limit coefficient of the charging power, and Ped is a state of electric vehicle charging. The above formulas describe charging and discharging states and capacity limits of the energy storage device in different time periods. The electric vehicle has become an indispensable load in the industrial and commercial park. Depending on different charging modes, a charging scheduling of the electric vehicle will vary. In general, the electric vehicle adopts a home charging mode, that is, a vehicle owner starts charging after returning home from work and stops charging when leaving for work. A start time of the electric vehicle charging follows a normal distribution, and its probability density function is:

$${f}_{t} ( x ) = \{ \begin{matrix}\frac{1}{{σ}_{s} \sqrt{2 π}} exp ( - \frac{{( x - {μ}_{s} )}^{2}}{2 {σ}_{s}^{2}} ) & {μ}_{s} - 12 < x < 24 \\ \frac{1}{{σ}_{s} \sqrt{2 π}} exp ( - \frac{{( x + 24 - {μ}_{s} )}^{2}}{2 {σ}_{s}^{2}} ) & 0 < x < {μ}_{s} - 12\end{matrix} ;$$

where: parameters σₛ and μₛ respectively represent a standard deviation and mean of the normal distribution controlling the start time of the electric vehicle charging, where σₛ=3.3, μₛ=18. According to the above formula, a charging start time table for the electric vehicle in the industrial and commercial park can be obtained, and then charging is performed for the vehicle owner according to a charging mode of the industrial and commercial park.

A capacity of the electric vehicle in the industrial and commercial park follows a uniform distribution, as shown in the formula below, where 20-60 kWh represents a common capacity range of electric vehicles on a market. A probability that the electric vehicle in the industrial and commercial park has a capacity within this range is uniformly distributed:

$${f}_{c} ( x ) = \{ \begin{matrix}\frac{1}{40} & 20 < x < 60 \\ 0 & otherwise\end{matrix} ;$$

a charging formula for the electric vehicle is similar to that of the energy storage device, and essentially still follows a process of a lithium-ion battery. This charging process is as follows:

$${SOC}_{i , t + 1} = {SOC}_{i , t} + \frac{{P}_{i , t}^{e v}}{{Q}_{i , y}^{e v}} Δ t$$

$${SOC}_{min} \leq {SOC}_{i , t} \leq {SOC}_{max} ;$$

where:

$${P}_{i , t}^{e v}$$

is a charging power of the electric vehicle, and

$${Q}_{i , t}^{e v}$$

is a battery capacity of the electric vehicle, determined by a uniform distribution equation for determining a capacity of electric vehicles in the industrial and commercial park. SOCₘᵢₙ ensures that the electric vehicle is charged to a minimum required state of charge (SOC) for operation to mainly prevent deep discharge of an electric vehicle battery during discharge, thereby extending a service life of the electric vehicle battery. SOCₘₐₓ corresponds to a maximum SOC that the electric vehicle can reach to prevent overcharging of the electric vehicle.

Charging modes of the electric vehicle include a quick charging mode and an intellectual charging mode. The quick charging mode is suitable for emergency charging demand and can achieve a full charge in a relatively short time, but the charging power is high, which may have an impact on battery life. The intellectual charging mode is suitable for a user who is not in a hurry to charge, in which a charging power is relatively low and can be dynamically adjusted according to an overall load in the industrial and commercial park and electricity price fluctuations, so as to reduce charging costs and avoid excessive load on the grid. Limits of the charging power are as follows:

$${P}^{e v} = \{ \begin{matrix}{P}^{ev , max} & quick charging \\ 0 \leq {P}_{i , t}^{ev} \leq {P}^{ev , max} & intellectual charging\end{matrix} ;$$

where:

$${P}_{i , t}^{ev}$$

is the charging power of the electric vehicle, where in the quick charging mode, the charging power equals a maximum allowable power of a charging pile in the industrial and commercial park, which is 20 kWh in general, and in the intellectual charging mode, the charging power ranges from 0 to the maximum power and can vary according to an overall load curve of the industrial and commercial park and real-time electricity price fluctuations, thereby achieving two objects: one is to prevent excessive electric vehicle charging in the industrial and commercial park during peak periods that could put pressure on the distribution network of the industrial and commercial park, and the other is to complete a charging demand while avoiding peak electricity price periods, thereby reducing charging costs for the vehicle owner.

The industrial and commercial park is equipped with the shared ES-PV system, and particularly during load peak periods, the system is required to give priority to satisfying internal loads of the industrial and commercial park. This can effectively reduce dependence of loads in the industrial and commercial park on the distribution network, because during an off-peak period, a load pressure on the distribution network is relatively low. In order to achieve this objective, the various types of loads in the industrial and commercial park is required to satisfy an electric energy balance constraint.

An electric energy balance formula is as follows:

$${L}_{t} = {L}_{t}^{b a s i c} + {P}_{t}^{fleet} ;$$

where: Lₜ is a total power demand of the industrial and commercial park, which consists of two parts, a part being

$${L}_{t}^{b a s i c} ,$$

that is, a basic load or une industrial and commercial park, which generally includes a power demand for users' daily electricity consumption, such as electricity for lighting, washing machines, and other basic facilities; and a second part being

$${P}_{t}^{fleet} ,$$

that is, an electric vehicle charging load in the industrial and commercial park, a size of which is determined by a penetration rate of electric vehicles in the industrial and commercial park, that is, if a charging power of one electric vehicle is

$${P}_{i , t}^{e v}$$

then a total fleet power of the industrial and commercial park basically depends on how many electric vehicles are equipped in the industrial and commercial park. At present, the distribution network of most industrial and commercial parks is sufficient to meet a basic power demand, but with the increase in the number of electric vehicles, a load pressure on the grid will gradually increase. Therefore, the electric vehicle charging load should be separately taken as an object of concern, not included in the basic load, and is required to be independently optimized and scheduled.

The reward function in the reinforcement learning plays a core role in guiding an agent's decision-making, determines how the agent evaluates its behavior, and directs the agent to approximate an objective behavior. To achieve this objective, we hope to use reinforcement learning to optimize the charging and discharging decisions of an energy storage system for the industrial and commercial park, especially during load peak periods, where the energy storage system should undertake part of the load pressure.

The penalty function is designed to constrain the agent when behaviors that do not conform to the objective occur, so as to reduce such behaviors. The penalty function is defined as:

$${Penalty}_{t}^{waste} = {P}_{t}^{waste} ;$$

where:

$${P}_{t}^{waste}$$

represents energy waste generated at this time step, specifically, a surplus electric energy from photovoltaic power generation that is not fully utilized, or an energy discharged by the energy storage system that exceeds a demand of the industrial and commercial park.

An energy output of a photovoltaic power generation system is required to satisfy a power demand of the industrial and commercial park and minimize waste. An energy balance formula for the photovoltaic system is as follows:

$${G}_{t} = {P}_{t}^{p , c} + {P}_{t}^{p , e} + {P}_{t}^{pv , waste} ;$$

where: Gₜ represents electric energy generated by the photovoltaic system at each time, a part of the electric energy is used by a user in the industrial and commercial park, denoted as

$${P}_{t}^{p , c} ;$$

and a part is stored by the energy storage, denoted as

$${P}_{t}^{p , e} .$$

If there is still remaining photovoltaic electric energy, it is denoted as

$${P}_{t}^{pv , waste} ,$$

indicating that this part of the electric energy is wasted.

A power demand of the user in the industrial and commercial park is also required to satisfy an electric energy balance constraint, so as to ensure a reasonable distribution of loads in the industrial and commercial park among various energy inputs. An energy balance formula for the user is as follows:

$${L}_{t} = {P}_{t}^{p , c} + {P}_{t}^{dis} + {P}_{t}^{g , c} - {P}_{t}^{e , waste} ;$$

Lₜ is a total power demand of the industrial and commercial park, a part of which comes from photovoltaic power generation, that is,

$${P}_{t}^{p , c} ;$$

a part comes from discharging of the energy storage system, that is,

$${P}_{t}^{dis} ;$$

and another part depends on the grid, that is,

$${P}_{t}^{g , c} .$$

If discharging of the energy storage system far exceeds a load demand of the industrial and commercial park, it is denoted as

$${P}_{t}^{e , waste} ,$$

indicating that this part of energy is wasted.

Charging electric energy of the energy storage system comes from purchased electricity from the grid and comes from power generation of the photovoltaic system. A charging power formula for the energy storage system is as follows:

$${P}_{t}^{ch} = {P}_{t}^{g , e} + {P}_{t}^{p , e} ;$$

where:

$${P}_{t}^{g , e}$$

is charging power from the power grid, and

$${P}_{t}^{p , e}$$

is charging power from the photovoltaic power generation system.

$${P}_{t}^{waste} = {P}_{t}^{pv , waste} + {P}_{t}^{e , waste} ;$$

The energy waste

$${P}_{t}^{waste}$$

generated in the entire industrial and commercial park comes from photovoltaic power generation that fails to be fully utilized, resulting in photovoltaic electric energy waste,

$${P}_{t}^{pv , waste} ,$$

and comes from discharging of the energy storage far exceeding a demand of the industrial and commercial park, resulting in electric energy waste of energy storage

$${P}_{t}^{e , waste} .$$

This part of electric energy waste not only affects power supply efficiency of the industrial and commercial park but also increases an energy consumption burden of the system, and therefore, in reinforcement learning, a penalty is required to reduce unnecessary waste behaviors. By designing an electric energy balance of the industrial and commercial park, it is possible to ensure that the shared ES-PV system can undertake loads in the industrial and commercial park. However, a successful implementation of this process depends on guidance of the reward function. Therefore, in order to effectively guide an operation of the shared ES-PV system, a reasonable reward function of the industrial and commercial park is required to be designed.

First, electric energy costs of the industrial and commercial park are required to consider electric energy purchase costs from the grid and from the energy storage system. The calculation formula is as follows:

$${Cost}_{t}^{s} = {Π}_{t}^{*} ( {P}_{t}^{g , c} + {P}_{t}^{g , e} ) ;$$

where:

$${Cost}_{t}^{s}$$

is the electric energy cost of the entire industrial and commercial park, πₜ* is an actual electricity price based on a local electricity price standard,

$${P}_{t}^{g , c}$$

is electric energy purchased from the grid by the industrial and commercial park, and

$${P}_{t}^{g , e}$$

is electric energy purchased from the grid by the energy storage system. The electric energy costs are closely related to fluctuations of loads in the industrial and commercial park and electricity prices of the grid; and therefore, reasonably optimizing an electric energy purchasing approach can significantly reduce electricity costs of the industrial and commercial park.

A charging behavior of the energy storage system not only involves electric energy storage but also causes certain cost losses, especially battery wear. The cost calculation formula is as follows:

$${Cost}_{t}^{wear} = \frac{{C}_{E}}{{η DL}_{C}} \vert {P}_{t}^{bat} \vert ;$$

This part is the cost losses caused by the charging behavior of the energy storage system, where, C_{E} is a unit energy cost of the battery, which can be an initial cost or a replacement cost of the battery; D is a depth of discharge of the battery, which represents an extent of discharge; and L_{c} is a cycle life of the battery, which represents the number of charge-discharge cycles that the battery can undergo under specific depth of discharge and conditions. The formula indicates that a wear cost of the battery is related to multiple factors, including the unit energy cost, efficiency, depth of discharge, cycle life, and charging and discharging power. By reasonably managing the charging and discharging strategy, the battery life can be effectively extended, and the wear cost can be reduced.

Considering the above factors, the reward function of the industrial and commercial park can be designed in the following form:

$${Reaward}_{t}^{s} = - {Cost}_{t}^{s} - {Cost}_{t}^{wear} - {Penalty}_{t}^{waste} ;$$

where:

$${Reaward}_{t}^{s}$$

is a reward of the industrial and commercial park at time t;

$${Cost}_{t}^{s}$$

is the electric energy costs of the industrial and commercial park, and an objective is to reduce power costs so as to reduce dependence of the industrial and commercial park on the grid;

$${Cost}_{t}^{wear}$$

is a wear cost of the energy storage system, which both considers a long-term health of the energy storage system and optimizes a usage degree of the battery, and

$${Penalty}_{t}^{waste}$$

is a penalty function to reduce electric energy waste and ensure efficient operation of the system.

By designing such a reward function, the system can self-adjust the charging and discharging strategy in a reinforcement learning process, not only optimizing economic costs but also extending a service life of the energy storage system and reducing energy waste, thereby achieving effective management of loads in the industrial and commercial park and reducing dependence on the distribution network.

After designing the reward function of the industrial and commercial park, a next step is to design a reinforcement learning algorithm. This algorithm is used to control the charging and discharging decisions of the energy storage system for the industrial and commercial park, where the system forms an optimal usage strategy based on different time situations, thereby maximizing a long-term reward of the industrial and commercial park.

A core task of the reinforcement learning is to enable the agent (which in this scenario is a scheduling controller of the energy storage system for the industrial and commercial park) to learn in an environment to maximize its long-term return through a series of actions. In this application scenario, the “actions” of the agent refer to decisions on a degree of charge and discharge of the energy storage system, and an objective is to maximize the reward function of the industrial and commercial park through these decisions, so as to ensure that while satisfying a load demand of the industrial and commercial park, power costs are reduced, a service life of the energy storage system is extended, and energy waste is reduced.

In a reinforcement learning framework, a state of the environment at each step is a random variable. In this case, the state of the environment is determined by multiple factors such as a current charging state of the energy storage system, the load demand, and a photovoltaic power generation amount. Assuming that at a certain time, the agent is in a state St, takes an action at, and then transits to a next state sₜ₊₁ and obtains a reward

$${Reaward}_{t}^{s} ,$$

then the state transition process can be expressed as:

$${s}_{t + 1} = f ( {s}_{t} , {a}_{t} ) ;$$

where: f is a state transition function, which represents a change of an environmental state after a certain action is taken in a certain state.

An objective of the agent is to maximize its cumulative return by selecting an appropriate action sequence. This is usually achieved through a value function. Given a current time t, the cumulative return Gₜ is a weighted sum of all rewards from performing actions starting from the current time to a termination time:

$${G}_{t} = {r}_{t + 1} + {γ r}_{t + 2} + {γ}^{2} {r}_{t + 3} + ⋯ = {\sum }_{k = 0}^{∞} {γ}^{k} {r}_{t + k + 1} ;$$

where: γ is a discount factor, generally between 0≤γ≤1. The discount factor controls a weight of future rewards, and the smaller the value is, the smaller an influence of future rewards on a current decision is. The reward function rₜ₊₁ in the formula is actually a simplified representation of

$${Reaward}_{t + 1}^{s} ,$$

that is, the reward function evaluates an influence of the current decision on the agent.

A policy π defines a probability distribution of an action taken by the agent in each state. The policy can be deterministic or stochastic.

$$π ( a \vert s ) = P ( {a}_{t} = a \vert {s}_{t} = s )$$

This is a formula of the stochastic policy, which represents a probability of taking an action a in a state s. In practical applications, the stochastic policy can help explore different decision paths to find an optimal policy.

Q-learning, which is a commonly used reinforcement learning method, is based on an idea of value iteration and gradually approximates the optimal policy by constantly updating an action value function. In the Q-learning, each pair of state St and action at has a corresponding Q value representing an expected return of taking the action in the state. An update rule of the Q-learning is as follows:

$$Q ( {s}_{t} , {a}_{t} ) ← Q ( {s}_{t} , {a}_{t} ) + α ( {r}_{t + 1} + {γmax}_{{a}^{′}} Q ( {s}_{t + 1} , {a}^{′} ) - Q ( {s}_{t} , {a}_{t} ) ) ;$$

where: α is a learning rate that controls a step size of each update; and maxₐ, Q(sₜ₊₁, a′) is a Q value corresponding to an optimal action among all possible actions a′ taken in a new state sₜ₊₁.

By constantly iterating and updating the Q value, the Q-learning method can gradually find the optimal policy, that is, to take an optimal action in each state to maximize the cumulative return.

The technical features of the embodiments shown above can be combined flexibly as needed. For the sake of brevity, all possible combinations of the technical features are not described in detail in the above embodiments. However, as long as the combinations of these technical features do not result in contradictions in practical applications, they shall be deemed to fall within the scope described in this specification.

It should be noted that this does not imply any limitation on the scope of the present patent of invention. According to the understanding of those skilled in the art, without departing from the concept of the present disclosure, modifications and improvements can still be made to the above embodiments, and these modifications and improvements fall within the scope of protection of the present disclosure. Therefore, the scope of protection of the present patent of invention shall be in accordance with the scope defined by the appended claims.

1. An intellectual scheduling method of a shared storage and charging system for an industrial and commercial park based on reinforcement learning, wherein specific steps are as follows:
(1) by modeling various types of loads in the industrial and commercial park that contains a shared energy storage and photovoltaic (ES-PV) system, controlling an energy balance of the shared ES-PV system to achieve intellectual scheduling and optimized management of energy, with a key focus on electricity demand of a user in a park, charging demand of an electric vehicle, and a supply situation of photovoltaic power generation;
(2) establishing a model of the shared ES-PV system, analyzing its charging and discharging characteristics, and calculating a degradation cost of a battery; and
(3) by designing a reward function, guiding a reinforcement learning algorithm to make optimal charging and discharging decisions at different times to maximize overall benefits of the industrial and commercial park, wherein in this process, a reinforcement learning agent constantly selects an action based on a current state, implements a corresponding charging and discharging strategy, and optimizes the charging and discharging decisions through a feedback reward signal; and the shared ES-PV system, through a plurality of iterations, gradually finds an optimal scheduling method to ensure a balance between power supply and demand, reduce energy waste, and extend battery service life.

2. The method as claimed in claim 1, wherein the modeling in step (1) is to establish interaction relationships among an energy storage device, the electric vehicle, and other loads, wherein the energy storage device in the modeling is used as an emergency power source and also performs charging during peak electricity price periods to reduce dependence on a distribution network, and various types of loads in the industrial and commercial park comprise:
the energy storage device is used to store electric energy that is consumed immediately in the industrial and commercial park, and a mathematical model for the energy storage device is shown in Formula (1):
$$\begin{matrix}{S}_{{ev}_{d , t + 1}} = {S}_{{ev}_{d , t}} + {P}_{d , t} Δ T & ∀ t ∈ T\end{matrix} \qquad ( 1 )$$
wherein: Sₑᵥ_{_{d,t}} is a state of the energy storage device at time t, P_{d,t} is a charging and discharging power, and ΔT is a time step;
a capacity range of the energy storage device is constrained by:
$$\begin{matrix}{p}_{dod} {S}_{{ev}_{max}} \leq {S}_{{ev}_{d , t}} \leq {S}_{{ev}_{max}} & ∀ t ∈ T\end{matrix} \qquad ( 2 )$$
$$\begin{matrix}{e}_{d , t} {P}_{{ev}_{min}} \leq {P}_{d , t} \leq {e}_{d , t} {P}_{{ev}_{max}} & ∀ t ∈ T\end{matrix} \qquad ( 3 )$$
$$\begin{matrix}{e}_{d , t} ∈ \{ 0 , 1 \} & ∀ t ∈ T\end{matrix} \qquad ( 4 )$$
$$\begin{matrix}{S}_{{ev}_{d , 19}} \leq {p}_{st} {S}_{{ev}_{max}} & ∀ t ∈ T\end{matrix} \qquad ( 5 )$$
$$\begin{matrix}{S}_{{ev}_{d , 7}} \leq {p}_{ed} {S}_{{ev}_{max}} & ∀ t ∈ T\end{matrix} \qquad ( 6 )$$
wherein: P_{dod} is a lower limit of a discharging power of the device, Sₑᵥ_{ₘₐₓ} is a maximum storage capacity of the device, eat is a charging and discharging state of a storage device at time t, Pₑᵥ_{ₘₐₓ} is an upper limit of a charging power, Sₑᵥ_{_{d,19}} and Sₑᵥ_{_{d,7}} are charging and discharging states of the device at times t=19 and t=7, respectively, Pₛₜ is an upper limit coefficient of the charging power, and ped is a state of electric vehicle charging; Formula (2)-Formula (6) are charging and discharging states and capacity limits of the energy storage device in different time periods;
the electric vehicle adjusts its charging scheduling according to different charging modes, wherein the electric vehicle adopts a home charging mode in which a vehicle owner starts charging after returning home from work and stops charging when leaving for work; a start time of the electric vehicle charging follows a normal distribution, and its probability density function is:
$${f}_{t} ( x ) = \{ \begin{matrix}\frac{1}{{σ}_{s} \sqrt{2 π}} exp ( - \frac{{( x - {μ}_{s} )}^{2}}{2 {σ}_{s}^{2}} ) & {μ}_{s} - 12 < x < 24 \\ \frac{1}{{σ}_{s} \sqrt{2 π}} exp ( - \frac{{( x + 24 - {μ}_{s} )}^{2}}{2 {σ}_{s}^{2}} ) & 0 < x < {μ}_{s} - 12\end{matrix} \qquad ( 7 )$$
wherein parameters σₛ and μₛ respectively represent a standard deviation and mean of the normal distribution controlling the start time of the electric vehicle charging, σₛ=3.3, μₛ=18; according to Formula (7), a charging start time table for the electric vehicle is obtained, and then charging is performed for the vehicle owner according to a corresponding charging mode;
a capacity of the electric vehicle in the industrial and commercial park follows a uniform distribution, as shown in Formula (8); wherein 20-60 kWh represents a common capacity range of electric vehicles on a market; a probability that the electric vehicle in the industrial and commercial park has a capacity within this range is uniformly distributed:
$${f}_{c} ( x ) = \{ \begin{matrix}\frac{1}{40} & 20 < x < 60 \\ 0 & otherwise\end{matrix} \qquad ( 8 )$$
a charging formula for the electric vehicle is similar to that of the energy storage device and follows a charging process of a lithium-ion battery; the charging process is expressed as Formula (9) and Formula (10):
$${SOC}_{i , t + 1} = {SOC}_{i , t} + \frac{{P}_{i , t}^{ev}}{{Q}_{i , t}^{ev}} Δ t \qquad ( 9 )$$
$${SOC}_{min} \leq {SOC}_{i , t} \leq {SOC}_{max} \qquad ( 10 )$$
wherein:
$${P}_{i , t}^{ev}$$
is a changing power of the electric vehicle, and
$${Q}_{i , t}^{ev}$$
is a battery capacity of the electric vehicle, determined by a uniform distribution equation for determining a capacity of electric vehicles in the industrial and commercial park; SOCₘᵢₙ ensures that the electric vehicle is charged to a minimum required state of charge (SOC) for operation to prevent deep discharge of an electric vehicle battery during discharge, thereby extending a service life of the electric vehicle battery; and SOCₘₐₓ corresponds to a maximum SOC that the electric vehicle reaches to prevent overcharging of the electric vehicle;
charging modes of the electric vehicle comprise a quick charging mode and an intellectual charging mode; the quick charging mode is suitable for emergency charging demand and achieve a full charge in a relatively short time; the intellectual charging mode is suitable for a user who is not in a hurry to charge, in which a charging power is relatively low and dynamically adjusted according to an overall load in the industrial and commercial park and electricity price fluctuations, so as to reduce charging costs and avoid excessive load on a grid; and
limits of the charging power are as follows:
$${P}_{i , t}^{ev} = \{ \begin{matrix}{P}^{ev , max} & quick charging \\ 0 \leq {P}_{i , t}^{ev} \leq {P}^{ev , max} & intellectual charging\end{matrix} \qquad ( 11 )$$
wherein:
$${P}_{i , t}^{ev}$$
is charging power of the electric vehicle, wherein in the quick charging mode, the charging power equals a maximum allowable power of a charging pile in the industrial and commercial park, which is 20 kWh, and in the intellectual charging mode, the charging power ranges from 0 to the maximum power and varies according to an overall load curve of the industrial and commercial park and real-time electricity price fluctuations, thereby achieving two objects: one is to prevent excessive electric vehicle charging in the industrial and commercial park during peak periods that puts pressure on the distribution network of the industrial and commercial park, and the other is to complete a charging demand while avoiding peak electricity price periods, thereby reducing charging costs for the vehicle owner.

3. The method as claimed in claim 1, wherein the industrial and commercial park described in step (2) is equipped with the shared ES-PV system, and during load peak periods, the shared ES-PV system is required to give priority to satisfying internal loads of the industrial and commercial park; so as to effectively reduce dependence of loads in the industrial and commercial park on the distribution network, and therefore, the various types of loads in the industrial and commercial park are required to satisfy an electric energy balance constraint;
an electric energy balance constraint formula is as follows:
$${L}_{t} = {L}_{t}^{basic} + {P}_{t}^{fleet} \qquad ( 12 )$$
wherein: Lₜ is a total power demand of the industrial and commercial park, which consists of two parts, a first part being
$${L}_{t}^{basic} ,$$
that is, a basic load of the park, comprising a power demand for daily electricity consumption; a second part being
$${P}_{t}^{fleet} ,$$
that is, an electric vehicle charging load in the industrial and commercial park, a size of which is determined by a penetration rate of electric vehicles in the industrial and commercial park, that is, if a charging power of one electric vehicle is
$${P}_{i , t}^{ev} ,$$
then a total fleet power of the industrial and commercial park basically depends on how many electric vehicles are equipped in the park; and the electric vehicle charging load is not comprised in the basic load and is required to be independently optimized and scheduled.

4. The method as claimed in claim 1, wherein the reward function in the reinforcement learning described in step (3) plays a core role in guiding an agent's decision-making, determines how the agent evaluates its behavior, and directs the agent to approximate an objective behavior; by reinforcement learning, the charging and discharging decisions of an energy storage system for the industrial and commercial park are optimized; especially during load peak periods, the energy storage system should undertake part of the load pressure;
a penalty function is adopted to reduce an occurrence of behaviors that do not conform to an agent's objective; the penalty function is defined as:
$${Penalty}_{t}^{waste} = {P}_{t}^{waste} \qquad ( 13 )$$
wherein:
$${P}_{t}^{waste}$$
represents energy waste generated at this time step, specifically, a surplus electric energy from photovoltaic power generation that is not fully utilized, or an energy discharged by the energy storage system that exceeds a demand of the industrial and commercial park;
an energy output of a photovoltaic power generation system is required to satisfy a power demand of the industrial and commercial park and minimize waste; an energy balance formula for the photovoltaic system is as follows:
$${G}_{t} = {P}_{t}^{p , c} + {P}_{t}^{p , e} + {P}_{t}^{pv , waste} \qquad ( 14 )$$
wherein: Gₜ represents electric energy generated by the photovoltaic system at each time, a part of the electric energy is used by a user in the industrial and commercial park, denoted as
$${P}_{t}^{p , c} ;$$
a part is stored by the energy storage, denoted as
$${P}_{t}^{p , e} ;$$
if there is still remaining photovoltaic electric energy, it is denoted as
$${P}_{t}^{pv , waste} ,$$
indicating that this part of the electric energy is wasted;
a power demand of the user in the industrial and commercial park is also required to satisfy an electric energy balance constraint, so as to ensure a reasonable distribution of loads in the industrial and commercial park among various energy inputs; an energy balance formula for the user is as follows:
$${L}_{t} = {P}_{t}^{p , c} + {P}_{t}^{d i s} + {P}_{t}^{g , c} - {P}_{t}^{e , waste} \qquad ( 15 )$$
where: Lₜ is a total power demand of the industrial and commercial park, a part of which comes from photovoltaic power generation, that is,
$${P}_{t}^{p , c} ;$$
a part comes from discharging of the energy storage system, that is,
$${P}_{t}^{d i s} ;$$
and another part depends on a grid, that is,
$${P}_{t}^{g , c} ;$$
if discharging of the energy storage system far exceeds a load demand of the industrial and commercial park, it is denoted as
$${P}_{t}^{e , waste} ,$$
indicating that this part of energy is wasted;
charging electric energy of the energy storage system comes from purchased electricity from the grid and comes from power generation of the photovoltaic system; a charging power formula for the energy storage system is as follows:
$${P}_{t}^{c h} = {P}_{t}^{g , e} + {P}_{t}^{p , e} \qquad ( 16 )$$
wherein:
$${P}_{t}^{g , e}$$
is charging power from the grid, and
$${P}_{t}^{p , e}$$
is charging power from the photovoltaic power generation system;
$${P}_{t}^{waste} = {P}_{t}^{pv , waste} + {P}_{t}^{e , waste} \qquad ( 17 )$$
the energy waste
$${P}_{t}^{waste}$$
generated in the entire industrial and commercial park comes from photovoltaic power generation that fails to be fully utilized, resulting in photovoltaic electric energy waste,
$${P}_{t}^{pv , waste} ,$$
and comes from discharging of the energy storage far exceeding a demand of the industrial and commercial park, resulting in electric energy waste of energy
$${storageP}_{t}^{e , waste} ;$$
and this part of electric energy waste not only affects power supply efficiency of the industrial and commercial park but also increases an energy consumption burden of the system, and therefore, in reinforcement learning, a penalty is required to reduce unnecessary waste behaviors.

5. The method as claimed in claim 4, wherein the reward function ensures that the shared ES-PV system undertakes loads in the industrial and commercial park through an electric energy balance of the industrial and commercial park;
electric energy cost of the industrial and commercial park are required to consider electric energy purchase costs from the grid and from the energy storage system, which are calculated as Formula (18):
$${Cost}_{t}^{s} = {\prod }_{t}^{*} ( {P}_{t}^{g , c} + {P}_{t}^{g , e} ) \qquad ( 18 )$$
wherein: Costₜ^{s} is the electric energy costs of the entire industrial and commercial park, πₜ^{s} is an actual electricity price based on a local electricity price standard,
$${P}_{t}^{g , c}$$
is electric energy purchased from the grid by the industrial and commercial park, and
$${P}_{t}^{g , e}$$
is electric energy purchased from the grid by the energy storage system; the electric energy costs are closely related to fluctuations in loads in the industrial and commercial park and electricity prices of the grid; and therefore, adopting an optimized electric energy purchasing approach significantly reduces electricity costs of the industrial and commercial park;
a charging behavior of the energy storage system not only involves electric energy storage but also causes cost losses, especially battery wear; the cost losses caused by the charging behavior of the energy storage system are calculated as Formula (19):
$${Cost}_{t}^{wear} = \frac{{C}_{E}}{η {DL}_{C}} \vert {P}_{t}^{bat} \vert \qquad ( 19 )$$
wherein: C_{E} is a unit energy cost of the battery, representing an initial cost or a replacement cost of the battery; D is a depth of discharge of the battery, which represents a degree of discharge; L_{c} is a cycle life of the battery, which represents a number of charging and discharging cycles that the battery undergoes under specific depth of discharge and conditions; a wear cost of the battery is related to an energy cost, efficiency, depth of discharge, cycle life, and charging and discharging power; by reasonably managing the charging and discharging strategy, the battery life is effectively extended and the wear cost is reduced;
a reward function of the industrial and commercial park is as shown in Formula (20):
$${Reaward}_{t}^{s} = - {Cost}_{t}^{s} - {Cost}_{t}^{wear} - {Penalty}_{t}^{waste} \qquad ( 20 )$$
wherein:
$${Reaward}_{t}^{s}$$
is a reward of the industrial and commercial park at time;
$${Cost}_{t}^{s}$$
is the electric energy cost of the industrial and commercial park, and an objective is to reduce power costs so as to reduce dependence of the industrial and commercial park on the grid;
$${Cost}_{t}^{wear}$$
is a wear cost of the energy storage system, which both considers a long-term health of the energy storage system and optimizes a usage degree of the battery;
$${Penalty}_{t}^{waste}$$
is a penalty function to reduce electric energy waste and ensure efficient operation of the system; and
through the reward function, the shared ES-PV self-adjusts the charging and discharging strategy in a reinforcement learning process, not only optimizing economic costs but also extending a service life of the energy storage system and reducing energy waste, thereby achieving effective management of loads in the industrial and commercial park and reducing dependence on the distribution network.

6. The method as claimed in claim 1, wherein the reinforcement learning algorithm described in step (3) is used to control the charging and discharging decisions of the energy storage system for the industrial and commercial park, wherein the system forms an optimal usage strategy based on different time situations, thereby maximizing a long-term reward of the industrial and commercial park;
a core task of the reinforcement learning is to enable the agent, which in this scenario is a scheduling controller of the energy storage system for the industrial and commercial park, to learn in an environment to maximize its long-term return through a series of actions; in this application scenario, the “actions” of the agent refer to decisions on a degree of charge and discharge of the energy storage system, and an objective is to maximize the reward function of the industrial and commercial park through these decisions, so as to ensure that while satisfying a load demand of the industrial and commercial park, power costs are reduced, a service life of the energy storage system is extended, and energy waste is reduced;
in a reinforcement learning framework, a state of the environment at each step is a random variable; in this case, the state of the environment is determined by a plurality of factors comprising a current charging state of the energy storage system, the load demand, and a photovoltaic power generation amount; assuming that at a certain time, the agent is in a state sₜ, takes an action aₜ, and then transits to a next state sₜ₊₁ and obtains a reward Reawardₜ^{s}, then a state transition process is expressed as:
$${s}_{t + 1} = f ( {s}_{t} , {a}_{t} ) \qquad ( 21 )$$
wherein: f is a state transition function, which represents a change of an environmental state after a certain action is taken in a certain state;
an objective of the agent is to maximize its cumulative return by selecting an appropriate action sequence; this is usually achieved through a value function; given a current time t, the cumulative return Gₜ is a weighted sum of all rewards from performing actions starting from the current time to a termination time:
$${G}_{t} = {r}_{t + 1} + γ {r}_{t + 2} + {γ}^{2} {r}_{t + 3}^{} + … = {\sum }_{k = 0}^{∞} {γ}^{k} {r}_{t + k + 1} \qquad ( 22 )$$
wherein: γ is a discount factor, generally between 0≤γ≤1; the discount factor controls a weight of future rewards, and the smaller the value is, the smaller an influence of future rewards on a current decision is; and a reward function rₜ₊₁ in Formula (22) is a simplified representation of
$${Reaward}_{t + 1}^{s} ,$$
that is, the reward function evaluates an influence of the current decision on the agent;
a policy π defines a probability distribution of an action taken by the agent in each state, and the policy is deterministic or stochastic;
$$π ( a \vert s ) = P ( {a}_{t} = a \vert {s}_{t} = s ) \qquad ( 23 )$$
the stochastic policy is shown in Formula (23), which represents a probability of taking an action a in a state s; in practical applications, the stochastic policy helps explore different decision paths to find an optimal policy;
a reinforcement learning method adopts a Q-learning method based on value iteration and gradually approximates the optimal policy by constantly updating an action value function; in the Q-learning method, each pair of state St and action at has a corresponding Q value representing an expected return of taking the action in the state; an update rule of the Q-learning method is as follows:
$$Q ( {s}_{t} , {a}_{t} ) ← Q ( {s}_{t} , {a}_{t} ) + α ( {r}_{t + 1} + γ {max}_{{a}^{′}} Q ( {s}_{t + 1} , {a}^{′} ) - Q ( {s}_{t} , {a}_{t} ) ) \qquad ( 24 )$$
wherein: α is a learning rate that controls a step size of each update; maxₐ, Q(sₜ₊₁, a′) is a Q value corresponding to an optimal action among all possible actions a′ taken in a new state sₜ₊₁; and
by constantly iterating and updating the Q value, the Q-learning method gradually finds the optimal policy, that is, to take an optimal action in each state to maximize the cumulative return.
